(19) United States
(12) Patent Application Publication
(10) Pub. No.: US 2010/0266042 A1
(43) Pub. Date: Oct. 21, 2010

(54) METHOD AND AN APPARATUS FOR DECODING/ENCODING A VIDEO SIGNAL

(76) Inventors: Han Suh Koo, Seoul (KR); Yeon Kwan Koo, Seoul (KR); Byeong Moon Jeon, Seoul (KR); Seung Wook Park, Seoul (KR); Yong Joon Jeon, Gyeonggi-do (KR)

Correspondence Address: HARNESS, DICKEY & PIERCE, P.L.C., P.O. BOX 8910, RESTON, VA, 20195, US

(21) Appl. No.: 12/449,893

(22) PCT Filed: Mar. 3, 2008
(86) PCT No.: PCT/KR2008/001209

§ 371 Date: Jan. 14, 2010

Related U.S. Application Data
(60) Provisional application No. 60/892,753, filed on Mar. 2, 2007.

(51) Int. Cl. H04N 11/02

(52) U.S. Cl. 375/240.16; 375/E07.104

(57) ABSTRACT

A method of decoding a video signal is disclosed. The present invention includes obtaining identification information indicating whether a coded picture of a current NAL unit is included in an inter-view picture group, obtaining inter-view reference information of a non-inter-view picture group according to the identification information, obtaining a motion vector according to the inter-view reference information of the non-inter-view picture group, deriving a position of a first corresponding block using the motion vector, and decoding a current block using motion information of the derived first corresponding block, wherein the inter-view reference information includes number information of reference views of the non-inter-view picture group.

### TECHNICAL FIELD

The present invention relates to coding of a video signal.

### BACKGROUND ART

Compression coding means a series of signal processing techniques for transmitting digitalized information via a communication circuit or storing the digitalized information in a form suitable for a storage medium. As targets of compression coding, there are audio, video, characters, etc. In particular, a technique for performing compression coding on video is called video sequence compression. A video sequence is generally characterized in having spatial redundancy or temporal redundancy.

### DISCLOSURE OF THE INVENTION

### Technical Problem

Accordingly, the present invention is directed to a method and apparatus for decoding/encoding a video signal that can substantially enhance efficiency in coding the video signal.

### Technical Solution

An object of the present invention is to provide a method and apparatus for decoding/encoding a video signal, by which motion compensation can be performed by obtaining motion information of a current picture based on relationship of inter-view pictures.

Another object of the present invention is to provide a method and apparatus for decoding/encoding a video signal, by which a restoration rate of a current picture can be raised using motion information of a reference view having high similarity to motion information of the current picture.

Another object of the present invention is to efficiently perform coding on a video signal by defining inter-view information capable of identifying a view of picture.

Another object of the present invention is to provide a method of managing reference pictures used for inter-view prediction, by which a video signal can be efficiently coded.

Another object of the present invention is to provide a method of predicting motion information of a video signal, by which the video signal can be efficiently processed.

Another object of the present invention is to provide a method of searching for a block corresponding to a current block, by which a video signal can be efficiently processed.

Another object of the present invention is to provide a method of performing a spatial direct mode in multi-view video coding, by which a video signal can be efficiently processed.

Another object of the present invention is to enhance compatibility between different kinds of codecs by defining syntax for codec compatibility.

Another object of the present invention is to enhance compatibility between codecs by defining syntax for rewriting of a multi-view video coded bitstream.

A further object of the present invention is to independently apply informations on various scalabilities to each view using independent sequence parameter set information.

### Advantageous Effects

According to the present invention, signal processing efficiency can be raised by predicting motion information using temporal and spatial correlations of a video sequence. More precise prediction is enabled by predicting coding information of a current block using coding information of a picture having high correlation with the current block, whereby an error value transport quantity is reduced to perform efficient coding. Even if motion information of a current block is not transported, it is able to calculate motion information very similar to that of the current block. Hence, a restoration rate is enhanced.

Moreover, coding can be efficiently carried out by providing a method of managing reference pictures used for inter-view prediction. In case that inter-view prediction is carried out by the present invention, a burden of a DPB (decoded picture buffer) is reduced. So, a coding rate can be enhanced and more accurate prediction is enabled to reduce the number of bits to be transported. More efficient coding is enabled using various kinds of configuration informations on a multi-view sequence. By defining a syntax for codec compatibility, it is able to raise compatibility between different kinds of codecs. And, it is able to perform more efficient coding by applying informations on various scalabilities to each view independently.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of a video signal decoding apparatus according to an embodiment of the present invention;

FIG. 2 is a diagram of configuration informations on a multi-view sequence that can be added to a multi-view sequence coded bitstream according to an embodiment of the present invention;

FIG. 3 is a diagram of an overall prediction structure of a multi-view sequence signal according to an embodiment of the present invention to explain a concept of an inter-view picture group;

FIG. 4 is a diagram of a syntax structure for rewriting a multi-view video coded bitstream into an AVC bitstream in case of decoding the multi-view video coded bitstream by AVC codec according to an embodiment of the present invention;

FIG. 5 is a diagram for explaining a method of managing a reference picture in multi-view video coding according to an embodiment of the present invention;

FIG. 6 is a diagram of a prediction structure for explaining a spatial direct mode in multi-view video coding according to an embodiment of the present invention;

FIG. 7 is a diagram for explaining a method of performing motion compensation in accordance with a presence or non-presence of motion skip according to an embodiment of the present invention;

FIG. 8 and FIG. 9 are diagrams for an example of a method of determining a reference view and a corresponding block from a reference view list for a current view according to an embodiment of the present invention; and

FIG. 10 and FIG. 11 are diagrams for examples of providing various scalabilities in multi-view video coding according to an embodiment of the present invention.

### BEST MODE

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of decoding a video signal according to the present invention includes obtaining identification information indicating whether a coded picture of a current NAL unit is included in an inter-view picture group, obtaining inter-view reference information of a non-inter-view picture group according to the identification information, obtaining a motion vector according to the inter-view reference information of the non-inter-view picture group, deriving a position of a first corresponding block using the motion vector, and decoding a current block using motion information of the derived first corresponding block, wherein the inter-view reference information includes number information of reference views of the non-inter-view picture group.

Preferably, the method further includes checking a block type of the derived first corresponding block, wherein it is determined whether to derive a position of a second corresponding block existing in a reference view differing from a view of the first corresponding block based on the block type of the first corresponding block.

More preferably, the positions of the first and second corresponding blocks are derived based on a predetermined order and the predetermined order is configured in a manner of preferentially using the reference view for a LO direction of the non-inter-view picture group and then using the reference view for a L1 direction of the non-inter-view picture group.

In this case, if the block type of the first corresponding block is an intra block, the reference view for the L1 direction is usable.

And, the reference views for the L0/L1 direction are used in order of being closest to a current view.

Preferably, the method further includes obtaining flag information indicating whether motion information of the current block will be derived, wherein the position of the first corresponding block is derived based on the flag information.

Preferably, the method further includes obtaining motion information of the first corresponding block and deriving motion information of the current block based on the motion information of the first corresponding block, wherein the current block is decoded using the motion information of the current block.

Preferably, the motion information includes a motion vector and a reference index.

Preferably, the motion vector is a global motion vector of the inter-view picture group.

To further achieve these and other advantages and in accordance with the purpose of the present invention, an apparatus for decoding a video signal includes a reference information obtaining unit obtaining inter-view reference information of a non-inter-view picture group according to identification information indicating whether a coded picture of a current NAL unit is included in an inter-view picture group and a corresponding block searching unit deriving a position of a corresponding block using a global motion vector of a inter-view picture group obtained according to the inter-view reference information of the non-inter-view picture group, wherein the inter-view reference information includes number information of reference views of the non-inter-view picture group.

Preferably, the video signal is received as a broadcast signal.

Preferably, the video signal is received via a digital medium. To further achieve these and other advantages and in accordance with the purpose of the present invention, a computer-readable medium includes a program for executing the method of claim 1, wherein the program is recorded in the computer-readable medium.

It is to be understood that both the foregoing general description and the following detailed description are exemplary and explanatory and are intended to provide further explanation of the invention as claimed.

### Mode for Invention

Reference will now be made in detail to the preferred embodiments of the present invention, examples of which are illustrated in the accompanying drawings. First of all, compression coding of video signal data considers spatial redundancy, spatial redundancy, scalable redundancy, and inter-view redundancy. And, compression coding is enabled by considering inter-view existing mutual redundancy in the course of the compression coding. Compression coding scheme, which takes inter-view redundancy into consideration, is just an embodiment of the present invention. And, the technical idea of the present invention is applicable to temporal redundancy, scalable redundancy, and the like. In this disclosure, coding can include both concepts of encoding and decoding. And, coding can be flexibly interpreted to correspond to the technical idea and scope of the present invention.

Looking into a bit sequence configuration of a video signal, there exists a separate layer structure called a NAL (network abstraction layer) between a VCL (video coding layer) dealing with a moving picture encoding process itself and a lower system that transports and stores encoded information. An output from an encoding process is VCL data and is mapped by NAL unit prior to transport or storage. Each NAL unit includes compressed video data or RBSP (raw byte sequence payload: result data of moving picture compression) that is the data corresponding to header information.

The NAL unit basically includes two parts, a NAL header and an RBSP. The NAL header includes flag information (nal_ref_idc) indicating whether a slice as a reference picture of the NAL unit is included and an identifier (nal_unit_type) indicating a type of the NAL unit. Compressed original data is stored in the RBSP. And, RBSP trailing bit is added to a last portion of the RBSP to represent a length of the RBSP as an 8-bit multiplication. As the types of the NAL unit, there are IDR (instantaneous decoding refresh) picture, SPS (sequence parameter set), PPS (picture parameter set), SEI (supplemental enhancement information), and the like.

In the standardization, requirements for various profiles and levels are set to enable implementation of a target product with an appropriate cost. In this case, a decoder should meet the requirements determined according to the corresponding profile and level. Thus, two concepts, ‘profile’ and ‘level’ are defined to indicate a function or parameter for representing how far the decoder can cope with a range of a compressed sequence. And, a profile identifier (profile_idc) can identify that a bitstream is based on a prescribed profile. The profile identifier means a flag indicating a profile on which a bitstream is based. For instance, in H.264/AVC, if a profile identifier is 66, it means that a bitstream is based on a baseline profile. If a profile identifier is 77, it means that a bitstream is based on a main profile. If a profile identifier is 88, it means that a bitstream is based on an extended profile. Moreover, the profile identifier can be included in a sequence parameter set.

So, in order to handle a multi-view sequence, it needs to be identified whether an inputted bitstream is a multi-view profile. If the inputted bitstream is the multi-view profile, it is necessary to add syntax to enable at least one additional information for multi-view to be transmitted. In this case, the multi-view profile indicates a profile mode for handling multi-view video as an additional technique of H.264/AVC. In MVC, it may be more efficient to add syntax as additional information for an MVC mode rather than unconditional syntax. For instance, when a profile identifier of AVC indicates a multi-view profile, if information for a multi-view sequence is added, it is able to raise encoding efficiency.

Sequence parameter set indicates header information containing information crossing over encoding of an overall sequence such as a profile, a level, and the like. A whole compressed moving picture, i.e., a sequence should start from a sequence header. So, a sequence parameter set corresponding to header information should arrive at a decoder before the data referring to the parameter set arrives. Namely, the sequence parameter set RBSP plays a role as the header information for the result data of the moving picture compression. Once a bitstream is inputted, a profile identifier preferentially identifies that the inputted bitstream is based on which one of a plurality of profiles. So, by adding a part for deciding whether an inputted bitstream relates to a multi-view profile (e.g., ‘If (profile_idc==MULTI_VIEW_PROFILE)’) to syntax, it is determined whether the inputted bitstream relates the multi-view profile. Various kinds of configuration information can be added only if the inputted bitstream is approved as relating to the multi-view profile. For instance, it is able to add a total number of views, a number of inter-view reference pictures, a view identification number of an inter-view reference picture, and the like. And, a decoded picture buffer can use various kinds of informations on an interview reference picture to construct and manage a reference picture list.

FIG. 1 is a schematic block diagram of an apparatus for decoding a video signal according to the present invention.

Referring to FIG. 1A, the decoding apparatus includes a parsing unit 100, an entropy decoding unit 200, an inverse quantization/inverse transform unit 300, an intra-predicting unit 400, a deblocking filter unit 500, a decoded picture buffer unit 600, an inter-prediction unit 700, and the like. And, the decoded picture buffer unit 600 includes a reference picture storing unit 610, a reference picture list constructing unit 620, a reference picture managing unit 630, and the like. Referring to FIG. 1B, the inter-prediction unit 700 includes a direct prediction mode identifying unit 710, a spatial direct prediction executing unit 720, and the like. And, the spatial direct prediction executing unit 720 can include a first variable deriving unit 721, a second variable deriving unit 722, and a motion information predicting unit 723. Moreover, the inter-prediction unit 700 can include a motion skip determining unit 730, a corresponding block searching unit 731, a motion information deriving unit 732, a motion compensating unit 733, and a motion information obtaining unit 740.

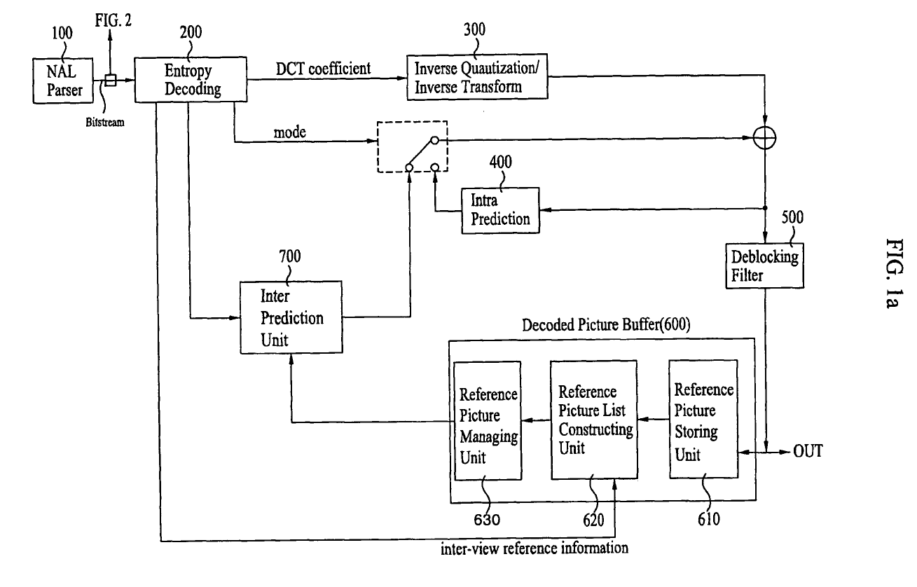

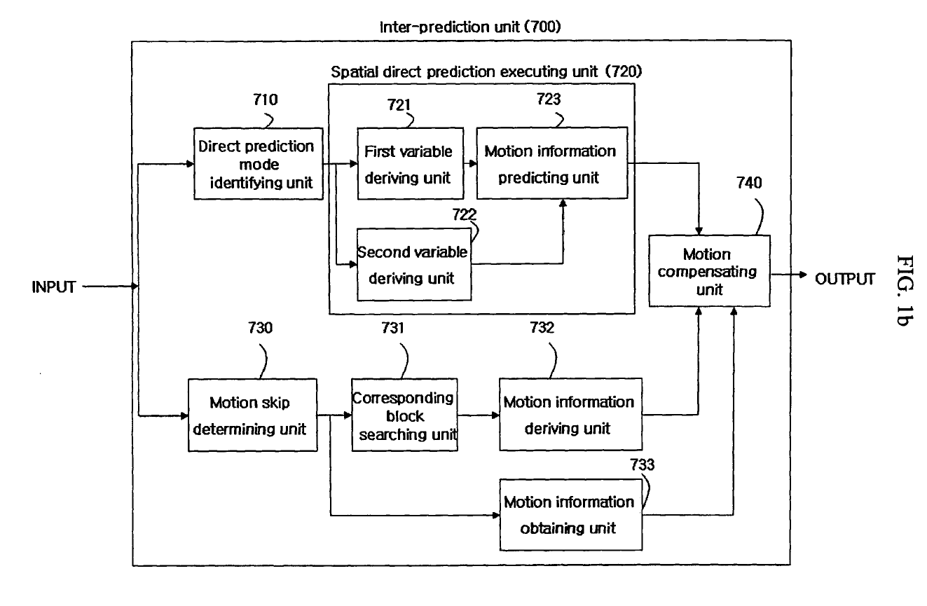

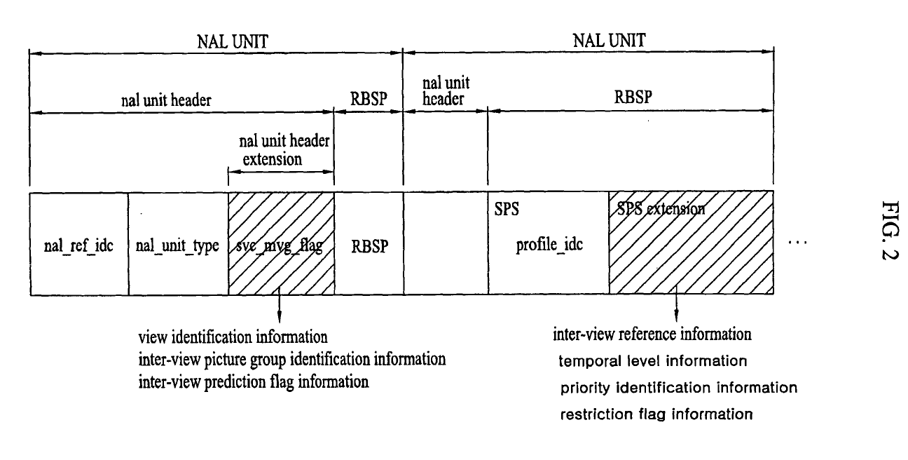

The parsing unit 100 carries out parsing by NAL unit to decode a received video sequence. In general, at least one sequence parameter set and at least one picture parameter set are transferred to a decoder before a slice header and slice data are decoded. In this case, various kinds of configuration informations can be included in a NAL header area or an extension area of a NAL header. Since MVC is an additional scheme for a conventional AVC scheme, it may be more efficient to add various configuration informations in case of an MVC bitstream only rather than unconditional addition. For instance, it is able to add flag information for identifying a presence or non-presence of an MVC bitstream in the NAL header area or the extension area of the NAL header. Only if an inputted bitstream is a multi-view sequence coded bitstream according to the flag information, it is able to add configuration informations for a multi-view sequence. For instance, the configuration informations can include view identification information, inter-view picture group identification information, inter-view prediction flag information, temporal level information, priority identification information, identification information indicating whether it is an instantaneous decoded picture for a view, and the like. They will be explained in detail with reference to FIG. 2.

The entropy decoding unit 200 carries out entropy decoding on a parsed bitstream and a coefficient of each macroblock, a motion vector, and the like are then extracted. The inverse quantization/inverse transform unit 300 obtains a coefficient value transformed by multiplying a received quantized value by a predetermined constant and then transforms the coefficient value inversely to reconstruct a pixel value. Using the reconstructed pixel value, the intra-predicting unit 400 performs intra-screen prediction from a decoded sample within a current picture. Meanwhile, the deblocking filter unit 500 is applied to each coded macroblock to reduce block distortion. A filter smoothens a block edge to enhance an image quality of a decoded frame. Selection of a filtering process depends on boundary strength and gradient of an image sample around a boundary. Pictures through filtering are outputted or stored in the decoded picture buffer unit 600 to be used as reference pictures.

The decoded picture buffer unit 600 plays a role in storing or opening the previously coded pictures to perform inter-picture prediction. In this case, to store the pictures in the decoded picture buffer unit 600 or to open the pictures, ‘frame_num’ of each picture and POC (picture order count) are used. So, in MVC, since there exist pictures in a view different from that of a current picture exists among the previously coded pictures, in order to use these pictures as reference pictures, view information for identifying a picture is usable together with the ‘frame_num’ and the POC. The decoded picture buffer unit 600 includes the reference picture storing unit 610, the reference picture list constructing unit 620, and the reference picture managing unit 630.

The reference picture storing unit 610 stores pictures that will be referred to for the coding of the current picture. The reference picture list constructing unit 620 constructs a list of reference pictures for the inter-picture prediction. In multi-view video coding, inter-view prediction is possible. So, if a current picture refers to a picture in another view, it may be necessary to construct a reference picture list for the inter-view prediction. Moreover, it is able to construct a reference picture list for performing both temporal prediction and inter-view prediction. For instance, if a current picture refers to a picture in a diagonal direction, it is able to construct a reference picture list in the diagonal direction. In this case, there are various methods for constructing the reference picture list in the diagonal direction. For example, it is able to define information (ref_list_idc) for identifying a reference picture list. If ref_list_idc=0, it means a reference picture list for temporal prediction. If it is 1, it indicates a reference picture list for inter-view prediction. If it is 2, it can indicate a reference picture list for both temporal prediction and inter-view prediction.

The reference picture list in the diagonal direction can be constructed using the reference picture list for the temporal prediction or the reference picture list for the inter-view prediction. For instance, it is able to align reference pictures in a diagonal direction to a reference picture list for temporal prediction. Alternatively, it is able to align reference pictures in a diagonal direction to a reference picture list for inter-view prediction. Thus, if lists in various directions are constructed, more efficient coding is possible. In this disclosure, the reference picture list for the temporal prediction and the reference picture list for the inter-view prediction are mainly described. And, the concept of the present invention is applicable to a reference picture list in a diagonal direction as well.

The reference picture list constructing unit 620 can use information on view in constructing the reference picture list for the inter-view prediction. For instance, inter-view reference information can be used. Inter-view reference information means information used to indicate an inter-view dependent relation. For instance, there can be a total number of views, a view identification number, a number of inter-view reference pictures, a view identification number of an inter-view reference picture, and the like.

The reference picture managing unit 630 manages reference pictures to realize inter-picture prediction more flexibly. For instance, a memory management control operation method and a sliding window method are usable. This is to manage a reference picture memory and a non-reference picture memory by unifying the memories into one memory and realize efficient memory management with a small memory. In multi-view video coding, since pictures in a view direction have the same picture order count, information for identifying a view of each of the pictures is usable in marking them. And, reference pictures managed in the above manner can be used by the inter-prediction unit 700.

Referring to FIG. 1B, the inter-prediction unit 700 can include a direct prediction mode identifying unit 710, a spatial direct prediction executing unit 720, a motion skip determining unit 730, a corresponding block searching unit 731, a motion information deriving unit 732, a motion information obtaining unit 733 and a motion compensating unit 740.

The motion compensating unit 740 compensates for a motion of a current block using informations transported from the entropy decoding unit 200. Motion vectors of blocks neighbor to the current block are extracted from a video signal and a motion vector of the current block are then obtained. And, the motion of the current block is compensated using the obtained motion vector predicted value and a differential vector extracted from the video signal. And, it is able to perform the motion compensation using one reference picture or a plurality of pictures. In multi-view video coding, in case that a current picture refers to pictures in different views, it is able to perform motion compensation using information for the inter-view prediction reference picture list stored in the decoded picture buffer unit 600. And, it is also able to perform motion compensation using view information for identifying a view of the corresponding picture. A direct prediction mode is an encoding mode for predicting motion information for a current block from motion information for an encoded block. Since this method is able to save bits required for decoding the motion information, compression efficiency is enhanced. For instance, a temporal direct mode predicts motion information for a current block using motion information correlation in a temporal direction. The temporal direct mode is effective when a speed of the motion in a sequence containing different motions is constant. In case that the temporal direct mode is used for multi-view video coding, inter-view motion vector should be taken into consideration.

For another example of the direct prediction mode, a spatial direct mode predicts motion information of a current block using motion information correlation in a spatial direction. The spatial direct mode is effective when a speed of motion varies in a sequence containing the same motions. Within a reference picture having a smallest reference number in a reverse direction reference picture list (List 1) of a current picture, it is able to predict motion information of the current picture using motion information of a block co-located with the current block. Yet, in multi-view video coding, the reference picture may exist in a view different from that of the current picture. In this case, various embodiments are usable in applying the spatial direct mode.

The inter-predicted pictures and the intra-predicted pictures by the above-explained processes are selected according to a prediction mode to reconstruct a current picture.

FIG. 2 is a diagram of configuration informations on a multi-view sequence addable to a multi-view sequence coded bitstream according to one embodiment of the present invention. FIG. 2 shows an example of a NAL-unit configuration to which configuration informations on a multi-view sequence can be added. NAL unit can mainly include NAL unit header and RBSP (raw byte sequence payload: result data of moving picture compression). And, the NAL unit header can include identification information (nal_ref_idc) indicating whether the NAL unit includes a slice of a reference picture and information (nal_unit_type) indicating a type of the NAL unit. And, an extension area of the NAL unit header can be limitedly included. For instance, if the information indicating the type of the NAL unit is associated with scalable video coding or indicates a prefix NAL unit, the NAL unit is able to include an extension area of the NAL unit header. In particular, if the nal_unit_type=20 or 14, the NAL unit is able to include the extension area of the NAL unit header. And, configuration informations for a multi-view sequence can be added to the extension area of the NAL unit header according to flag information (svc_mvc_flag) capable of identifying whether it is MVC bitstream.

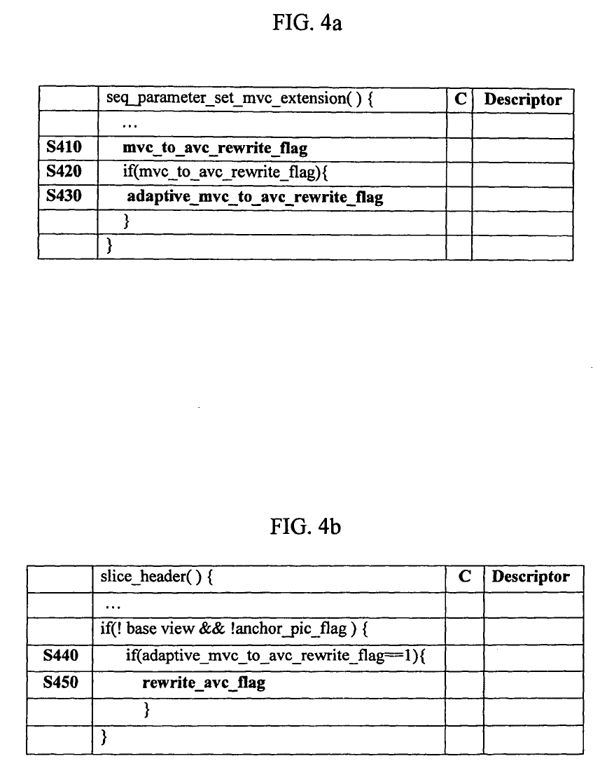

For another instance, if the information indicating the type of the NAL unit is information indicating a sequence parameter set, the RBSP can include information for the sequence parameter set. In particular, if nal_unit_type=7, the RBSP can include information for a sequence parameter set. In this case, the sequence parameter set can include an extension area of the sequence parameter set according to profile information. For example, if profile information (profile_idc) is a profile relevant to multi-view video coding, the sequence parameter set can include an extension area of the sequence parameter set. Alternatively, a subset sequence parameter set can include an extension area of a sequence parameter set according to profile information. The extension area of the sequence parameter set can include inter-view reference information indicating inter-view dependency. Moreover, the extension area of the sequence parameter set can include restriction flag information for restricting a specific syntax for codec compatibility. This will be explained in detail with reference to FIG. 4.

Various configuration informations on a multi-view sequence, e.g., configuration informations that can be included in an extension area of NAL unit header or configuration informations that can be included in an extension area of a sequence parameter set are explained in detail as follows.

First of all, view identification information means information for discriminating a picture in a current view from a picture in a different view. In coding a video sequence signal, POC (picture order count) and ‘frame_num’ are used to identify each picture. In case of a multi-view video sequence, inter-view prediction is carried out. So, identification information to discriminate a picture in a current view from a picture in another view is needed. Thus, it is necessary to define view identification information for identifying a view of a picture. The view identification information can be obtained from a header area of a video signal. For instance, the header area can be a NAL header area, an extension area of a NAL header, or a slice header area. Information on a picture in a view different from that of a current picture is obtained using the view identification information and it is able to decode the video signal using the information on the picture in the different view.

The view identification information is applicable to an overall encoding/decoding process of the video signal. For instance, view identification information can be used to indicate inter-view dependency. Number information of inter-view reference picture, view identification information of an inter-view reference picture and the like may be needed to indicate the inter-view dependency. Like the number information of the inter-view reference picture and the view identification information of the inter-view reference picture, informations used to indicate the inter-view dependency are called inter-view reference information. In this case, the view identification information can be used to indicate the view identification information of the inter-view reference picture. The inter-view reference picture may mean a reference picture used in performing inter-view prediction for a current picture. And, the view identification information can be applied to multi-view video coding using ‘frame_num’ that considers a view instead of considering a specific view identifier.

Inter-view picture group identification information means information capable of identifying whether a coded picture of a current NAL unit is included in an inter-view picture group. In this case, the inter-view picture group means a coded picture that only refers to a slice that all slices exist in a frame on a same time zone. For instance, it means a coded picture that refers to a slice in a different view only but does not refer to a slice in a current view. In decoding a multi-view sequence, an inter-view random access may be possible. For inter-view prediction, inter-view reference information is necessary. In obtaining the inter-view reference information, inter-view picture group identification information is usable. For instance, if a current picture corresponds to an inter-view picture group, inter-view reference information on the inter-view picture group can be obtained. If a current picture corresponds to a non-inter-view picture group, inter-view reference information on the non-inter-view picture group can be obtained.

Thus, in case that inter-view reference information is obtained based on inter-view picture group identification information, it is able to perform inter-view random access more efficiently. This is because inter-view reference relation between pictures in an inter-view picture group can differ from that in a non-inter-view picture group. And, in case of an inter-view picture group, pictures in a plurality of views can be referred to. For instance, a picture of a virtual view is generated from pictures in a plurality of views and it is then able to predict a current picture using the picture of the virtual view.

In constructing a reference picture list, the inter-view picture group identification information can be used.

In this case, the reference picture list can include a reference picture list for inter-view prediction. And, the reference picture list for the inter-view prediction can be added to the reference picture list. For instance, in case of initializing a reference picture list or modifying the reference picture list, the inter-view picture group identification information can be used. And, it can be also used to manage the added reference pictures for the inter-view prediction. For instance, by dividing the reference pictures into an inter-view picture group and a non-inter-view picture group, it is able to make a mark indicating that reference pictures failing to be used in performing inter-view prediction shall not be used. And, the inter-view picture group identification information is applicable to a hypothetical reference decoder.

Inter-view prediction flag information means information indicating whether a coded picture of a current NAL unit is used for inter-view prediction. The inter-view prediction flag information is usable for a part where temporal prediction or inter-view prediction is performed. In this case, identification information indicating whether NAL unit includes a slice of a reference picture can be used together. For instance, although a current NAL unit fails to include a slice of a reference picture according to the identification information, if it is used for inter-view prediction, the current NAL unit can be a reference picture used for inter-view prediction only. According to the identification information, if a current NAL unit includes a slice of a reference picture and used for inter-view prediction, the current NAL unit can be used for temporal prediction and inter-view prediction. If NAL unit fails to include a slice of a reference picture according to the identification information, it can be stored in a decoded picture buffer. This is because, in case that a coded picture of a current NAL unit is used for inter-view prediction according to the inter-view prediction flag information, it needs to be stored.

Aside from a case of using both of the flag information and the identification information together, one identification information can indicate whether a coded picture of a current NAL unit is used for temporal prediction or/and inter-view prediction.

And, the inter-view prediction flag information can be used for a single loop decoding process. In case that a coded picture of a current NAL unit is not used for inter-view prediction according to the inter-view prediction flag information, decoding can be performed in part. For instance, intra-macroblock is completely decoded, whereas decoding of inter-macroblock can be performed for only residual information of the inter-macroblock. Hence, it is able to reduce complexity of a decoder. This can be efficient if it is unnecessary to reconstruct a sequence by specifically performing motion compensation in different views when a user is looking at a view in a specific view only without viewing a sequence in entire views.

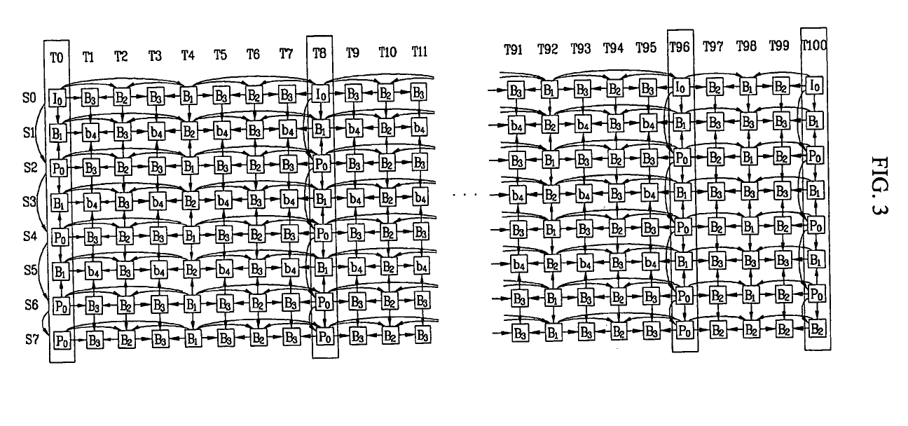

The diagram shown in FIG. 3 is used to explain one embodiment of the present invention.

For instance, a coding order may correspond to S0, S1 and S1 in considering a portion of the diagram shown in FIG. 3. Assume that a picture to be currently coded is a picture B₃ on a time zone T2 in a view S1. In this case, a picture B₂ on the time zone T2 in a view S0 and a picture B₂ on the time zone T2 in a view S2 can be used for inter-view prediction. If the picture B₂ on the time zone T2 in the view S0 is used for the inter-view prediction, the inter-view prediction flag information can be set to 1. If the picture B₂ on the time zone T2 in the view S0 is not used for the inter-view prediction, the flag information can be set to 0. In this case, if inter-view prediction flag information of all slices in the view S0 is 0, it may be unnecessary to decode the entire slices in the view S0. Hence, coding efficiency can be enhanced.

For another instance, if inter-view prediction flag information of all slices in the view S0 is not 0, i.e., if at least one is set to 1, decoding is mandatory even if a slice is set to 0. Since the picture B₂ on the time zone T2 in the view S0 is not used for decoding of a current picture, assuming that decoding is not executed by setting the inter-view prediction information to 0, it is unable to reconstruct a picture B₃ on the time zone T1 in the view S0, which uses the picture B₂ on the time zone T2 in the view S0, and a picture B₃ on a time zone T3 in the view S0 in case of decoding slices in the view S0. Hence, they should be reconstructed regardless of the inter-view prediction flag information.

For further instance, the inter-view prediction flag information is usable for a decoded picture buffer (DPB).

If the inter-view prediction flag information is not provided, the picture B₂ on the time zone T2 in the view S0 should be unconditionally stored in the decoded picture buffer. Yet, if it is able to know that the inter-view prediction flag information is 0, the picture B₂ on the time zone T2 in the view S0 may not be stored in the decoded picture buffer. Hence, it is able to save a memory of the decoded picture buffer.

Temporal level information means information on a hierarchical structure to provide temporal scalability from a video signal. Though the temporal level information, it is able to provide a user with a sequence on various time zones.

Priority identification information means information capable of identifying a priority of NAL unit. It is able to provide view scalability using the priority identification information. For example, it is able to define view level information using the priority identification information. In this case, view level information means information on a hierarchical structure for providing view scalability from a video signal. In a multi-view video sequence, it is necessary to define a level for a time and a level for a view to provide a user with various temporal and view sequences. In case of defining the above level information, it is able to use temporal scalability and view scalability. Hence, a user is able to view a sequence at a specific time and view only or a sequence according to another condition for restriction only. The level information can be set differently in various ways according to its referential condition. For instance, the level information can be set different according to camera location or camera alignment. And, the level information can be determined by considering view dependency. For instance, a level for a view having an inter-view picture group of I picture is set to 0, a level for a view having an inter-view picture group of P picture is set to 1, and a level for a view having an inter-view picture group of B picture is set to 2. Thus, the level value can be assigned to the priority identification information. Moreover, the level information can be randomly set without being based on a special reference.

Restriction flag information may mean flag information for rewriting of a multi-view video coded bitstream for codec compatibility. For compatibility with conventional codec, in case that a multi-view video coded bitstream is decoded by AVC codec for example, it is necessary to rewrite the multi-view video coded bitstream into an AVC bitstream. In this case, the restriction flag information can block syntax information that is applicable to the multi-view video coded bitstream only. By blocking it, the multi-view video coded bitstream can be transformed into the AVC bitstream by a simple transform process. For instance, it can be represented as mvc_to_avc_rewrite_flag. This will be explained in detail with reference to FIG. 4.

Various embodiments for providing an efficient decoding method of a video signal are explained in the following description.

FIG. 3 is a diagram of an overall prediction structure of a multi-view sequence signal according to one embodiment of the present invention to explain a concept of an inter-view picture group.

Referring to FIGS. 3, T0 to T100 on a horizontal axis indicate frames according to time and S0 to S7 on a vertical axis indicate frames according to view. For instance, pictures at T0 mean sequences captured by different cameras on the same time zone T0, while pictures at S0 mean sequences captured by a single camera on different time zones. And, arrows in the drawing indicate predicted directions and orders of the respective pictures. For instance, a picture P0 in a view S2 on a time zone T0 is a picture predicted from I0, which becomes a reference picture of a picture P0 in a view S4 on the time zone T0. And, it becomes a reference picture of pictures B1 and B2 on time zones T4 and T2 in the view S2, respectively.

For a multi-view sequence decoding process, an inter-view random access may be required. So, an access to a random view should be possible by minimizing the decoding effort. In this case, a concept of an inter-view picture group may be needed to realize an efficient access. The definition of the inter-view picture group was mentioned in FIG. 2. For instance, in FIG. 3, if a picture I0 in a view S0 on a time zone T0 corresponds to an inter-view picture group, all pictures in different views on the same time zone, i.e., the time zone T0 can correspond to the inter-view picture group. For another instance, if a picture I0 in a view S0 on a time zone T8 corresponds to an inter-view picture group, all pictures in different views on the same time zone, i.e., the time zone T8 can correspond to the inter-view picture group. Likewise, all pictures in T16, . . . , T96, and T100 become an example of the inter-view picture group as well.

According to another embodiment, in an overall prediction structure of MVC, GOP can start from a I picture. And, the I picture is compatible with H.264/AVC. So, all inter-view picture groups compatible with H.264/AVC can become the I picture. Yet, in case of replacing the I pictures by P picture, more efficient coding is possible. In particular, more efficient coding is enabled using a prediction structure that GOP is made to start from P picture compatible with H.264/AVC.

In this case, if the inter-view picture group is re-defined, it becomes a coded picture capable of referring to a slice on a different time zone in a same view as well as a slice that all slices exist in a frame on a same time zone. Yet, the case of referring to a slice on a different time zone in a same view may be limited to an inter-view picture group compatible with H.264/AVC only.

After the inter-view picture group has been decoded, all of the sequentially coded pictures are decoded from the picture decoded ahead of the inter-view picture group in an output order without inter-prediction.

Considering the overall coding structure of the multi-view video sequence shown in FIG. 3, since inter-view dependency of an inter-view picture group differs from that of a non-inter-view picture group, it is necessary to discriminate the inter-view picture group and the non-inter-view picture group from each other according to the inter-view picture group identification information.

The inter-view reference information means information indicating what kind of structure is used to predict inter-view sequences. This can be obtained from a data area of a video signal. For instance, it can be obtained from a sequence parameter set area. And, the inter-view reference information can be obtained using the number of reference pictures and view information of the reference pictures. For instance, after a total number of views has been obtained, it is able to obtain view identification information for identifying each view based on the total number of the views. And, number information of inter-view reference pictures, which indicates a number of reference pictures for a reference direction of each view, can be obtained. According to the number information of the inter-view reference pictures, it is able to obtain view identification information of each inter-view reference picture.

Through this method, the inter-view reference information can be obtained. And, the inter-view reference information can be obtained in a manner of being categorized into a case of an inter-view picture group and a case of a non-inter-view picture group. This can be known using inter-view picture group identification information indicating whether a coded slice in a current NAL corresponds to an inter-view picture group. The inter-view picture group identification information can be obtained from an extension area of NAL header or a slice layer area.

The inter-view reference information obtained according to the inter-view picture group identification information is usable for construction, management and the like of a reference picture list.

FIG. 4 is a diagram of a syntax structure for rewriting a multi-view video coded bitstream into an AVC bitstream in case of decoding the multi-view video coded bitstream by AVC codec according to an embodiment of the present invention.

For codec compatibility, other information capable of restricting information on a bitstream coded by a different codec may be necessary. Other information capable of blocking information on a bitstream coded by the different codec may be necessary to facilitate a bitstream format to be converted. For instance, for codec compatibility, it is able to define flag information for rewriting of a multi-view video coded bitstream.

For compatibility with conventional codec, in case that a multi-view video coded bitstream is decoded by AVC codec for example, it is necessary to rewrite the multi-view video coded bitstream into an AVC bitstream. In this case, restriction flag information can restrict syntax information applicable to the multi-view video coded bitstream only. In this case, the restriction flag information may mean flag information indicating whether to rewrite a multi-view video coded bitstream into an AVC bitstream. By restricting the syntax information applicable to the multi-view video coded bitstream only, it is able to transform the multi-view video coded bitstream into an AVC stream through the simple transform process. For instance, it can be represented as mvc_to_avc_rewrite_flag [S410]. The restriction flag information can be obtained from a sequence parameter set, a sub-sequence parameter set or an extension area of the sub-sequence parameter set. And, the restriction flag information can be obtained from a slice header.

It is able to restrict a syntax element used for specific codec only by the restriction flag information. And, a syntax element for a specific process of a decoding process can be restricted. For instance, in multi-view video coding, the restriction flag information can be applied to a non-inter-view picture group only. Through this, each view may not need completely reconstructed neighbor views and can be coded in a single view.

According to another embodiment of the present invention, referring to FIG. 4A, based on the restriction flag information, it is able to define adaptive flag information indicating whether the restriction flag information will be used in a slice header. For instance, in case that a multi-view video coded bitstream is rewritten into an AVC bitstream according to the restriction flag information [S420], it is able to obtain adaptive flag information (adaptive_mvc_to_avc_rewrite_flag) [S430].

For another embodiment, it is able to obtain flag information indicating whether to rewrite a multi-view video coded bitstream into an AVC bitstream [S450], based on the adaptive flag information [S440]. For instance, this can be represented as rewrite_avc_flag. In this case, the steps S440 and S450 are just applicable to a view that is not a reference view. And, the steps S440 and S450 are just applicable to a case that a current slice corresponds to a non-inter-view picture group according to inter-view picture group identification information. For instance, if ‘rewrite_avc_flag=1’ of a current slice, rewrite_avc_flag of slices belonging to a view referred to by a current view will be 1. Namely, if a current view for rewriting by AVC is determined, rewrite_avc_flag of slices belonging to a view referred to by the current view can be automatically set to 1. For the slices belonging to the view referred to by the current view, it is unnecessary to reconstruct all pixel data but necessary to decode motion information required for the current view only. The rewrite_avc_flag can be obtained from a slice header. The flag information obtained from the slice header can play a role in rendering a slice header of a multi-view video coded bitstream into a same header of an AVC bitstream to enable decoding by AVC codec.

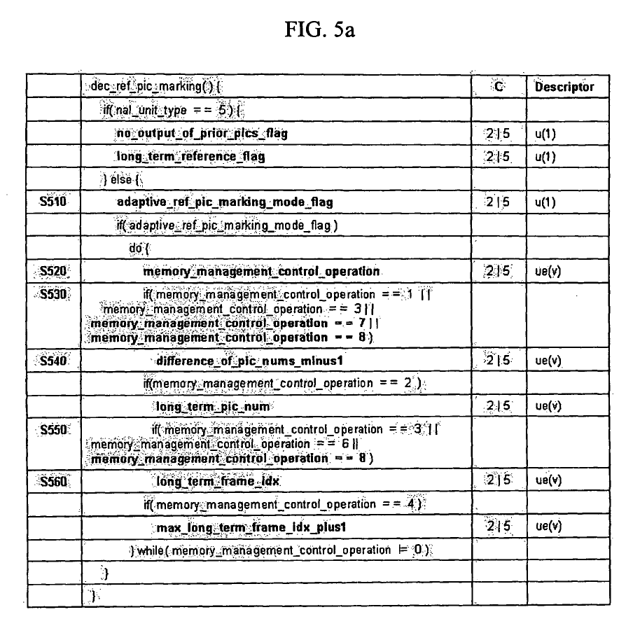

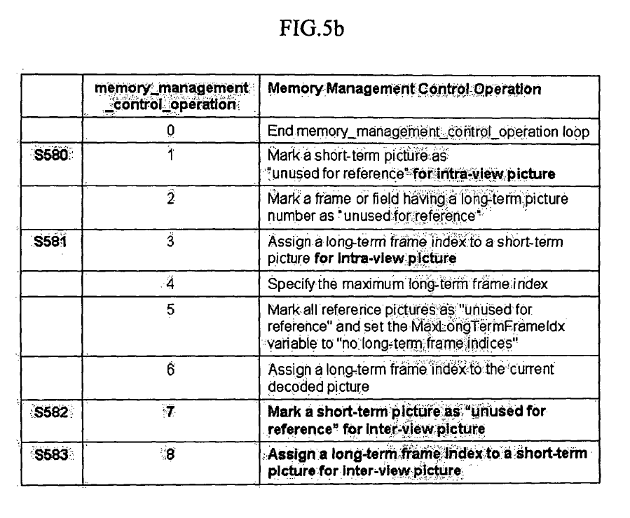

FIG. 5 is a diagram for explaining a method of managing a reference picture in multi-view video coding according to an embodiment of the present invention.

Referring to FIG. 1A, a reference picture list constructing unit 620 can include a variable deriving unit (not shown in the drawing), a reference picture list initializing unit (not shown in the drawing), and a reference picture list reordering unit (not shown in the drawing).

The variable deriving unit derives variables used for reference picture list initialization. For instance, the variable can be derived using ‘frame_num’ indicating a picture identification number. In particular, variables FrameNum and FrameNumWrap are usable for each short-term reference picture. First of all, the variable FrameNum is equal to a value of a syntax element frame_num. The variable FrameNumWrap can be used for the decoded picture buffer unit 600 to assign a small number to each reference picture. And, the variable FrameNumWrap can be derived from the variable FrameNum. So, it is able to derive a variable PicNum using the derived variable FrameNumWrap. In this case, the variable PicNum can mean an identification number of a picture used by the decoded picture buffer unit 600. In case of indicating a long-term reference picture, a variable LongTermPicNum is usable.

In order to construct a reference picture list for inter-view prediction, it is able to derive a first variable (e.g., ViewNum) to construct a reference picture list for inter-view prediction. For instance, it is able to derive a second variable (e.g., ViewId) using ‘view_id’ for identifying a view of a picture. First of all, the second variable can be equal to a value of the ‘view_id’ that is the syntax element. And, a third variable (e.g., ViewIdWrap) can be used for the decoded picture buffer unit 600 to assign a small view identification number to each reference picture and can be derived from the second variable. In this case, the first variable ViewNum can mean a view identification number of picture used by the decoded picture buffer unit 600. Yet, since the number of reference pictures used for inter-view prediction in multi-view video coding may be relatively smaller than that used for temporal prediction, it may not define a separate variable to indicate a view identification number of a long-term reference picture.

The reference picture list initializing unit (not shown in the drawing) initializes a reference picture list using the above-mentioned variables. In this case, an initialization process for the reference picture list may differ according to a slice type. For instance, in case of decoding a P slice, it is able to assign a reference index based on a decoding order. In case of decoding a B slice, it is able to assign a reference index based on a picture output order. In case of initializing a reference picture list for inter-view prediction, it is able to assign a number to a reference picture based on the first variable, i.e., the variable derived from view identification information of an inter-view reference picture.

The reference picture list reordering unit (not shown in the drawing) plays a role in improving a compression ratio by assigning a smaller index to a picture frequently referred to in the initialized reference picture list. A reference index designating a reference picture is encoded by a block unit. This is because a small bit is assigned if a reference index for coding gets smaller. Once the reordering step is completed, a reference picture list is constructed.

And, the reference picture list managing unit 630 manages a reference picture to perform inter-prediction more flexibly. In multi-view video coding, since pictures in view direction have the same picture order count, information for identifying a view of each picture may be usable for marking of them.

Reference picture can be marked as ‘non-reference picture’, ‘short-term reference picture’ or ‘long-term reference picture’. In multi-view video coding, when a reference picture is marked as a short-term reference picture or a long-term reference picture, it is necessary to discriminate whether the reference picture is a reference picture for prediction in time direction or a reference picture for prediction in view direction.

First of all, if a current NAL is a reference picture, it is able to perform a marking step of a decoded picture. As mentioned in the foregoing description of FIG. 1A, an adaptive memory management control operation method or a sliding window method is usable as a method of managing a reference picture. It is able to obtain flag information indicating which one of the methods will be used [S510]. For instance, if adaptive_ref_pic_marking_mode_flag is 0, the sliding window method can be used. If adaptive_ref_pic_marking_mode_flag is 1, the adaptive memory management control operation method can be used.

Adaptive memory management control operation method in accordance with the flag information according to an embodiment of the present invention is explained as follows. First of all, it is able to obtain identification information for controlling a storage or opening of a reference picture to adaptively manage a memory [S520]. For instance, memory_management_control_operation is obtained and a reference picture can be then stored or opened according to a value of the identification information (memory_management_control_operation). In particular, for example, referring to FIG. 5B, if the identification information is 1, it is able to mark a short-term reference picture for temporal direction prediction as ‘non-reference picture’ [S580]. Namely, a short-term reference picture specified among reference pictures for temporal direction prediction is opened and then changed into a non-reference picture. If the identification information is 3, it is able to mark a long-term reference picture for temporal direction prediction as ‘short-term reference picture’ [S581]. Namely, a short-term reference picture specified from reference pictures for temporal direction prediction can be modified into a long-term reference picture.

In multi-view video coding, when a reference picture is marked as a short-term reference picture or a long-term reference picture, it is able to allocate different identification information according to whether the reference picture is a reference picture for temporal direction prediction or a reference picture for view directional prediction. For instance, if the identification information is 7, it is able to mark a short-term reference picture for view direction prediction as ‘non-reference picture’ [S582]. Namely, a short-term reference picture specified among reference pictures for view direction prediction is opened and then modified into a non-reference picture. If the identification information is 8, it is able to mark a long-term reference picture for view direction prediction as ‘short-term reference picture’ [S583]. Namely, it is able to modify a specified short-term reference picture among reference pictures for view direction prediction into a long-term reference picture.

If the identification information is 1, 3, 7 or 8 [S530], it is able to obtain a difference value difference_of_pic_nums_minus1) of a picture identification number (PicNum) or view identification number (ViewNum) [S540]. The difference value is usable to assign a frame index of a long-term reference picture to a short-term reference picture. And, the difference value is usable to mark a short-term reference picture as a non-reference picture. In case that the reference pictures are reference pictures for temporal direction prediction, the picture identification number is available. In case that the reference pictures are reference pictures for view direction prediction, the view identification information is available.

In particular, if the identification information is 7, it is usable to mark a short-term reference picture as a non-reference picture. And, the difference value may mean a difference value of a view identification number. The view identification information of the short-term reference picture can be represented as Formula 1.

ViewNum=(view_id of current view)−(difference_of_pic_nums minus1+1) [Formula 1]

Short-term reference picture corresponding to the view identification number (ViewNum) can be marked as a non-reference picture.

For another instance, if the identification information is 8 [S550], the difference value can be used to assign a frame index of a long-term reference picture to a short-term reference picture [S560]. And, the difference value may mean a difference value of a view identification number. Using the difference value, a view identification number (ViewNum) can be derived as Formula 1. The view identification number refers to a picture marked as a short-term reference picture.

Thus, the operation of storing and opening a reference picture according to the identification information keeps being executed. In a view when the identification information is coded into a value of 0, the storing and opening operation is terminated.

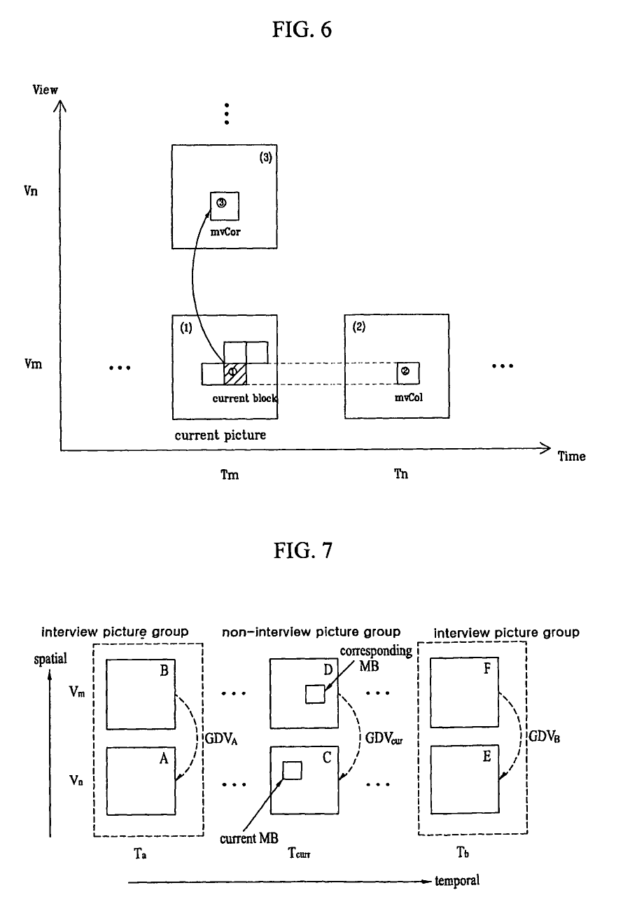

FIG. 6 is a diagram of a prediction structure for explaining a spatial direct mode in multi-view video coding according to an embodiment of the present invention. First of all, terminologies to be used need to be defined in advance of explaining embodiments to which the spatial direct mode is applied. For instance, in direct prediction mode, a picture having a smallest reference index among List 1 reference pictures can be defined as an anchor picture. In picture output order, a reference picture (2) closest in inverse direction of a current picture can become an anchor picture. And, a block \textcircled{2} of an anchor picture co-located with a current block \textcircled{1} can be defined as an anchor block. In this case, it is able to define a motion vector in List0 direction of the anchor block as mvCol. If there is no motion vector in List0 direction of the anchor block and if there is a motion vector in List1 direction, the motion vector in the List1 direction can be set to mvCol. In this case, in case of a B picture, it is able to use two random pictures as reference pictures regardless of temporal or spatial order. Predictions used for this are called List0 prediction and List1 prediction. For instance, List0 prediction may mean prediction for a forward direction (temporally preceding direction) and List1 prediction may mean prediction for reverse direction. In direct prediction mode, motion information of a current block can be predicted using motion information of the anchor block. In this case, motion information may mean motion vector, reference index and the like.

Referring to FIG. 1, the direct prediction mode identifying unit 710 identifies a prediction mode of a current slice. For instance, in case that a slice type of a current slice is a B slice, a direct prediction mode is available. In this case, it is able to use a direct prediction mode flag indicating whether a temporal direct mode or a spatial direct mode in the direct prediction mode will be used. The direct prediction mode flag can be obtained from a slice header. In case that the spatial direct mode is applied according to the direct prediction mode flag, it is able to obtain motion information of blocks neighbor to a current block in the first place. For instance, assuming that a block left to a current block \textcircled{1} is named a neighbor block A, that a block above the current block \textcircled{1} is named a neighbor block B and that a block at a right upper side of the current block \textcircled{1} is named a neighbor block C, it is able to obtain motion information of each of the neighbor blocks A, B and C.

The first variable deriving unit 721 is able to derive a reference index for List0/1 direction of a current block using motion information of neighbor blocks. And, it is able to derive a first variable based on the reference index of the current block. In this case, the first variable may mean a variable (directZeroPredictionFlag) used to predict a motion vector of a current block as a random value. For instance, a reference index for List0/1 direction of a current block can be derived as a smallest value of reference indexes of the neighbor blocks. For this, Formula 2 is usable.

refIdxL0=MinPositive(refIdxL0A, MinPositive(refIdxL0B,refIdxL0C))

refIdxL1=MinPositive(refIdxL1A, MinPositive(refIdxL1B,refIdxL1C))
where, MinPositive(x,y)=Min(x,y) (x≧0 & y≧0) Max(x,y) (other cases)

In particular, it becomes MinPositive(0,1)=0. Namely, if there exist two valid indexes, a small value can be obtained. Alternatively, it becomes MinPositive(−1, 0)=0. Namely, it is able to obtain a great value as an index value valid if one valid index exists. For example, if two neighbor blocks are intra-coded blocks or unusable, a great value ‘−1’ is obtained. Hence, if a result value is made to become an invalid value, there should not exist at least one valid value.

First of all, it is able to set the first variable as an initial value of the first variable to 0. In case that all the derived reference indexes derived for the List0/1 direction are smaller than 0, the reference index of the current block for the List0/1 direction can be set to 0. And, the first variable can be set to a value indicating that the reference picture of the current block does not exist. In this case, the case that all the derived reference indexes for the List0/1 direction are smaller than 0 may mean a case that the neighbor block is an intra-coded block or a case that the neighbor block becomes unavailable due to some reasons. If so, it is able to set the motion vector of the current block to 0 by setting the first variable to 1.

The second variable deriving unit 722 is able to derive a second variable using motion information on an anchor block within an anchor picture. In this case, the second variable may mean a variable (colZeroFlag) used to predict a motion vector of a current block as a random value. For instance, in case that motion information of an anchor block satisfies predetermined conditions, it is able to set the second variable to 1. If the second variable is set to 1, it is able to set a motion vector of a current block for List0/1 direction to 0. The predetermined conditions can be described as follows. First of all, a picture having a smallest reference index among reference pictures for List1 direction should be a short-term reference picture. Secondly, a reference index of a referred picture of an anchor block should be 0. Thirdly, a horizontal or vertical component size of a motion vector of an anchor block should be equal to or smaller than ±1 pixel.

Namely, it may mean a case that there is almost no motion. Thus, if the predetermined conditions are fully satisfied, it is determined that it is a sequence having almost no motion. Hence, the motion vector of the current block is then set to 0.

The motion information predicting unit 723 is able to predict motion information of a current block based on the derived first and second variables. For instance, if the first variable is set to 1, it is able to set a motion vector of a current block for List0/1 direction to 0. If the second variable is set to 1, it is able to set a motion vector of a current block for List0/1 direction to 0. The setting to 0 or 1 is just exemplary and the first or second variable can be set to other predetermined values to use. Besides, it is able to predict motion information of a current block from motion information of neighbor blocks within a current picture.

In the embodiment having the present invention applied thereto, since a view direction needs to considered, it is necessary to explain the aforesaid terminologies in addition. For instance, an anchor picture may mean a picture having a smallest reference index among Listo/1 reference pictures in view direction. And, an anchor block means a block co-located with a current block in time direction or may mean a corresponding block shifted by a disparity vector by considering an inter-view disparity difference in view direction. And, a motion vector can include a meaning of a disparity vector indicating an inter-view disparity difference. In this case, the disparity vector means an inter-object or inter-picture disparity difference between two views different from each other or may mean a global disparity vector. In this case, a motion vector can correspond to a partial area (e.g., macroblock, block, pixel, etc.) and the global disparity vector may mean a motion vector corresponding to a whole area including the partial area. The whole area can correspond to a macroblock, slice, picture or sequence. In some cases, it can correspond to at least one object area within a picture or a background. And, a reference index may mean view identification information for identifying a view of picture in view direction. Hence, the terminologies in this disclosure can be flexibly interpreted according to the technical idea and technical scope of the present invention.

First of all, in case that a current block \textcircled{1} refers to a picture in view direction, it is able to use a picture (3) having a smallest reference index among reference pictures in view direction. In this case, the reference index can mean view identification information Vₙ. And, it is able to use motion information of a corresponding block \textcircled{3} shifted by a disparity vector within the reference picture (3) in the view direction. In this case, it is able to define a motion vector of the corresponding block as mvCor.

According to an embodiment of the present invention, a spatial direct mode in multi-view video coding is explained as follows. First of all, when the first variable deriving unit 721 uses motion information of neighbor blocks, reference indexes of the neighbor blocks may mean view identification information. For instance, in case that all reference indexes of the neighbor blocks indicate a picture in view direction, a reference index of a current block for List0/1 direction can be derived into a smallest value of the view identification information of the neighbor blocks. In this case, the second variable deriving unit 722 is able to use motion information of a corresponding block in the process of deriving a second variable. For instance, conditions for setting a motion vector of a current block for List0/1 direction can be applied in the following manner. First of all, a picture having a smallest reference index among reference pictures for List0/1 direction should be a short-term reference picture. In this case, the reference index can be view identification information. Secondly, a reference index of a picture referred to by a corresponding block should be 0. In this case, the reference index can be view identification information. Thirdly, a horizontal or vertical component size of a motion vector mvCor of a corresponding block \textcircled{3} should be equal to or smaller than ± pixel. In this case, the motion vector can be a disparity vector.

For another instance, in case that all reference indexes of the neighbor blocks indicate a picture in time direction, it is able to execute a spatial direct mode using the above-mentioned method.

According to another embodiment of the present invention, in multi-view video coding, it is necessary to efficiently apply a process for deriving the second variable. For instance, more efficient coding is enabled by checking correlation between motion information of a current block and motion information of a corresponding block of an anchor picture. In particular, assume that a current block and a corresponding block exist on a same view. In case that the motion information of the corresponding block indicates a block on a different view while the motion information of the current block indicates a block on the same view, it can be regarded that correlation between the two motion informations is lowered. In case that the motion information of the corresponding block indicates a block on the same view while the motion information of the current block indicates a block on a different view, it can be regarded that correlation between the two motion informations is lowered. Meanwhile, assume that a current block and a corresponding block exist on views different from each other, respectively. Likewise, in case that the motion information of the corresponding block indicates a block on a different view while the motion information of the current block indicates a block on the same view, it can be regarded that correlation between the two motion informations is lowered. In case that the motion information of the corresponding block indicates a block on the same view while the motion information of the current block indicates a block on a different view, it can be regarded that correlation between the two motion informations is lowered.

Therefore, if there exists correlation by comparing motion information of a current block to that of a corresponding block, more efficient coding is enabled by deriving a second variable. The motion information predicting unit 723 is able to predict motion information of a current block based on the derived first and second variables. First of all, if the first variable is set to 1, a motion vector of a current block for List0/1 direction can be set to 0. If the second variable is set to 1, a motion vector of a current block for List0/1 direction can be set to 0. If the second variable is set to 1, if a reference index is 0, and if there exists correlation between motion information of a current block and motion information of a corresponding block, it is able to set a motion vector of the current block to 0. In this case, the corresponding block may be a co-located block with an anchor picture. And, if there exists the correlation between the motion information of the current block and the motion information of the corresponding block, it may mean a case that the motion informations direct the same direction. For instance, assume that a current block and a corresponding block exist on a same view. If motion information of the current block indicates a block on the same view and if motion information of the corresponding block indicates a block on the same view, it can be regarded that correlation exists between the two motion informations. If the motion information of the current block indicates a block on a different view and if the motion information of the corresponding block indicates a block on the different view, it can be regarded that correlation exists between the two motion informations. Likewise, assuming that a current block and a corresponding block exist on views different from each other, respectively, the corresponding determination can be made in the same manner.

According to another embodiment of the present invention, detailed methods for deciding correlation between motion informations of current and corresponding blocks are explained as follows.

For instance, it is able to define a prediction type (predTypeL0, predTypeL1) of motion information (mvL0, mvL1) of a current block. Namely, it is able to define a prediction type indicating whether it is motion information in time direction or motion information in view direction. Likewise, it is able to define a prediction type (predTypeColL0, predtypeCilL1) of motion information (mvColL0, mvColL1) of a corresponding block. It is then able to determine whether the prediction type of the motion information of the current block is identical to that of the motion information of the corresponding block. If the prediction types are identical to each other, it is able to determine that a derived second variable is valid. In this case, it is able to define a variable indicating whether the derived second variable is valid or not. If it is set to ‘colZeroFlagValidLX’, if the prediction types are identical, it can be set to ‘colZeroFlagValidLX=1’. If they are not identical, it can be set to ‘colZeroFlagValidLX=0’.

According to another embodiment of the present invention, a second variable for L0 direction and a second variable for L1 direction are respectively defined and then usable in deriving each mvLX.

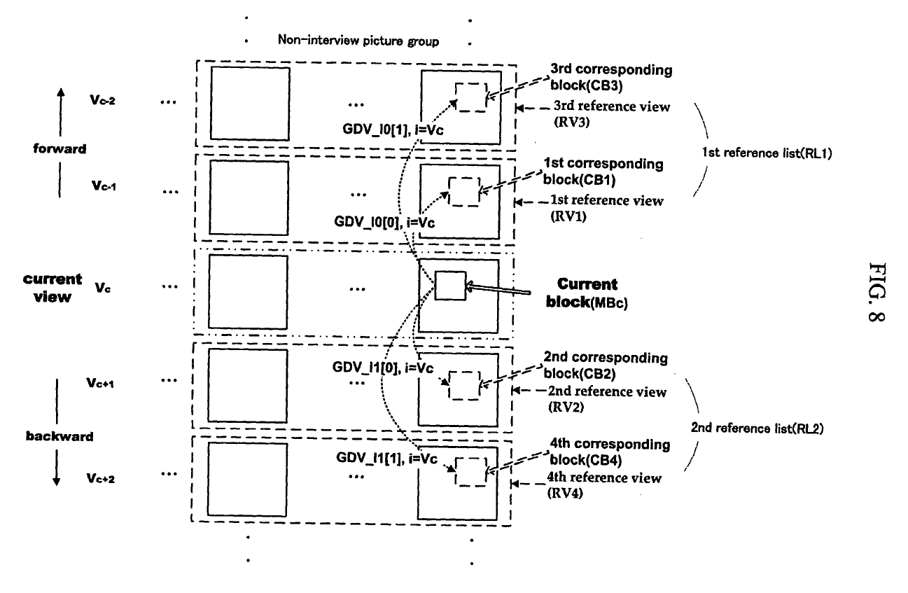

FIG. 7 is a diagram for explaining a method of performing motion compensation in accordance with a presence or non-presence of motion skip according to an embodiment of the present invention. The motion skip determining unit 730 determines whether to derive motion information of a current block or not. For instance, it is able to use a motion skip flag. If motion_skip_flag=1, the motion skip determining unit 730 performs a motion skip, i.e., the motion skip determining unit 730 derives motion information of the current block.

On the other hand, if motion_skip_flag=0, the motion skip determining unit 730 does not perform the motion skip but obtains transported motion information. In this case, the motion information can include a motion vector, a reference index, a block type and the like. In case that the motion skip is performed by the motion skip determining unit 730, the corresponding block searching unit 731 searches for a corresponding block. The motion information deriving unit 732 is able to derive motion information of the current block using the motion information of the corresponding blocks. The motion compensating unit 740 then performs motion compensation using the derived motion information. Meanwhile, if the motion skip is not performed by the motion skip determining unit 730, the motion information obtaining unit 733 obtains the transported motion information. The motion compensating unit 740 then performs the motion compensation using the obtained motion information.

According to an embodiment of the present invention, it is able to predict coding information of a current block for a second domain using coding information of a first domain for the second domain. In this case, it is able to obtain block information as the coding information together with the motion information. For instance, in a skip mode, information of a block coded ahead of a current block is utilized for information of a current block. In applying the skip mode, information existing on different domains are usable. This is explained with reference to detailed examples as follows.

For first example, it is able to assume that relative motion relations of objects (or backgrounds) within two different view sequences in a time Ta are similarly maintained in a time Tb sufficiently close to the time Ta. In this case, view direction coding information in the time Ta has high correlation with view direction coding information in the time Tb. If motion information of a corresponding block on a different time zone in a same view is used intact, it is able to obtain high coding efficiency. And, it is able to use motion skip information indicating whether this method is used or not. In case that a motion skip mode is applied according to the motion skip information, it is able to predict such motion information as a block type, a motion vector and a reference index from a corresponding block of a current block. Hence, it is able to reduce a bit amount required for coding the motion information. For instance, if motion_skip_flag is 0, the motion skip mode is not applied. If motion_skip_flag is 1, the motion skip mode is applied to the current block. And, the motion skip information can be located on a macroblock layer. For instance, the motion skip information is located in an extension area of a macroblock layer and is then able to preferentially indicate whether a decoder brings motion information from a bitstream.

For second example, like the former example, the same method is usable in a manner of changing the first and second domains which are the algorithm applied axes. In particular, it is highly probable that an object (or a background) within a view Va in a same time Ta and an object (or a background) within a view Vb neighboring to the view Va may have similar motion information. In this case, if motion information of a corresponding block on a same time zone in a different view is brought intact and then used, it is able to obtain high coding efficiency. And, it is able to use motion skip information indicating whether such a method is used or not.

Using motion information of a block neighboring to a current block, an encoder predicts motion information of the current block and then transports a difference value between a real motion vector and a predicted motion vector. Likewise, a decoder determines whether a reference index of a picture referred to by a current macroblock is identical to that of a picture referred to by a neighbor block and then correspondingly obtains a motion vector predicted value. For instance, in case that there exists a single block having a same reference index of a current macroblcok among the neighbor blocks, a motion vector of the neighbor block is used as it is. In other cases, a median value of motion vectors of the neighbor blocks is used.

In multi-view video coding, a reference picture can exist not only on a time axis but also on a view axis. Due to this characteristic, if a reference index of a current block differs from that of a neighbor block, it is highly probable that the motion vectors will have no correlation. If so, accuracy of a motion vector predicted value is considerably lowered. Hence, a new motion vector predicting method using inter-view correlation according to one embodiment of the present invention is proposed.

For instance, a motion vector generated between views may be dependent on depth of each object. If a depth of sequence has no considerable change spatially and if a motion of a sequence according to a variation of a time axis is not considerable, the depth itself at a position of each macroblock will not be considerably changed. In this case, the depth may mean information capable of indicating an inter-view disparity difference. Since influence of global motion vectors basically exists between cameras, although a depth is changed slightly, if a global motion vector is sufficiently larger than the depth change, using the global motion vector can be more efficient than using a time direction motion vector of a neighbor block having no correlation.

In this case, the global motion vector may mean a motion vector applicable to a predetermined area in common. For instance, if a motion vector corresponds to a partial area (e.g., macroblock, block, pixel, etc.), a global motion vector or a global disparity vector is a motion vector corresponding to a whole area including the partial area. For instance, the whole area may correspond to a single slice, a single picture or a whole sequence. And, the whole area may correspond to at least one object within a picture, a background or a predetermined area. The global motion vector can be a value of a pixel unit or ¼ pixel unit or a value of 4×4 unit, 8×8 unit or macroblock unit.

According to an embodiment of the present invention, it is able to predict a motion vector of a current block using inter-view motion information of a co-located block. In this case, the co-located block may be a block adjacent to a current block existing in a same picture or corresponds to a block co-located with the current block included in a different picture. For instance, in case of a different picture in a different view, it can be a spatial co-located block. In case of a different picture in a same view, it can be a temporal co-located block.

In a multi-view video coding structure, a random access can be performed by positioning pictures for prediction in only a view direction with a predetermined time interval. Thus, if two pictures for predicting motion information in view direction only are decoded, it is able to apply a new motion vector predicting method to the pictures temporally existing between the two decoded pictures. For instance, it is able to obtain a view direction motion vector from a picture for prediction in view direction only and this can be stored by 4×4 block unit. In case that an illumination difference is considerable in performing view direction prediction only, it may frequently happen that coding is carried out by intra-prediction. In this case, a motion vector can be set to 0. Yet, if coding is mainly carried out by intra-prediction use to a considerable illumination difference, many macroblocks, of which information on a motion vector in view direction is unknown, are generated. To compensate for this, in case of intra-prediction, it is able to calculate a virtual inter-view motion vector using a motion vector of a neighbor block. And, it is able to set the virtual inter-view motion vector to a motion vector of a block coded by the intra-prediction.

After the inter-view motion information has been obtained from the two decoded pictures, it is able to code hierarchical B pictures existing between the decoded pictures. In this case, the two decoded pictures may be an inter-view picture group. In this case, the inter-view picture group means a coded picture that only refers to a slice that all slices are in a frame on a same time zone. For instance, it means a coded picture that refers to a slice in a different view only without referring to a slice in a current view.

Meanwhile, in a method of predicting a motion vector of a current block, a corresponding block existing in a view different from a view of a current block and coding information of the current block can be then predicted using coding information of the corresponding block. First of all, a method of finding a corresponding block existing in a view different from that of a current block is explained as follows.

For instance, a corresponding block may be a block indicated by a view direction motion vector of a current block. In this case, the view direction motion vector means a vector indicating inter-view disparity difference or a global motion vector. In this case, the meaning of the global motion vector has been explained in the foregoing description. And, the global motion vector may indicate a corresponding macroblock position of a neighboring view on the same temporal instant of a current block. Referring to FIG. 7, pictures A and B exist in time Ta, pictures C and D exist in time Tcurr, and pictures E and F exist in time Tb. In this case, the pictures A and B in the time Ta and the pictures in the time Tb may be an inter-view picture group. And, the pictures C and D in the time Tcurr may be a non-inter-view picture group. The pictures A, C and E exist in the same view Vn. And, the pictures B, D and F exist in the same vie Vm. The picture C is a picture to be currently decoded. And, a corresponding macroblock (MB) of the picture D is a block indicated by a global motion vector GDVcurr of a current block (current MB) in view direction. The global motion vector can be obtained by a macroblock unit between a current picture and a picture in a neighboring view. In this case, information on the neighboring view can be known by information indicating inter-view reference relation (view dependency).

The information indicating the inter-view reference relation (view dependency) is the information indicating what kind of structure is used to predict inter-view sequences. This can be obtained from a data area of a video signal. For instance, it can be obtained from a sequence parameter set for example. And, the inter-view reference information can be recognized using the number information of reference pictures and the view information of the reference pictures. For instance, after the total number of views has been obtained, it is able to recognize vie information for discriminating each view based on the total number of views. And, it is able to obtain the number of reference pictures for a reference direction for each view. According to the number of reference pictures, it is able to obtain view information of each reference picture. Through this process, the inter-view reference information can be obtained. And, the inter-view reference information can be recognized in a manner of being divided into a case of an inter-view picture group and a case of a non-inter-view picture group. This can be known using inter-view picture group identification information indicating whether a coded slice in a current NAL corresponds to an inter-view picture group.

A method of obtaining the global motion vector may differ according to the inter-view picture group identification information. For instance, in case that a current picture corresponds to an inter-view picture group, it is able to obtain the global motion vector from a received bitstream. In case that a current picture corresponds to a non-inter-view picture group, it can be derived from the global motion vector of the inter-view picture group.

In doing so, information indicating time and distance can be used together with the global motion vector of the inter-view picture group. For instance, referring to FIG. 7, assuming that a global motion vector of a picture A is set to GDVa and assuming that a global motion vector of a picture E is set to GDVb, a global motion vector of a current picture C corresponding to a non-inter-view picture group can be obtained using global motion vectors of pictures A and E corresponding to the inter-view picture group and the time distance information. For instance, the time distance information may include POC (picture order count) indicating a picture output order. Hence, it is able to derive the global motion vector of the current picture using Formula 3.

$${GDV}_{cur} = {GDV}_{A} + [ \frac{{T}_{cur} - {T}_{A}}{{T}_{B} - {T}_{A}} \times ( {GDV}_{B} - {GDV}_{A} ) ] \qquad [ Formula 3 ]$$

The block indicated by the derived global motion vector of the current picture can be regarded as a corresponding block to predict coding information of the current block.

All motion information and mode information of the corresponding block are usable to predict coding information of the current block. The coding information can include such information required for coding a current block as motion information, information on illumination compensation, weight prediction information and the like. In case that a motion skip mode is applied to a current macroblock, it is able to intactly use motion information of a previously coded picture in a different view as motion information of the current block instead of coding motion information of the current macroblock. In this case, the motion skip mode can include a case of obtaining motion information of a current block by depending on motion information of a corresponding block in a neighboring view. For instance, in case that a motion skip mode is applied to a current macroblock, all motion information of the corresponding block, e.g., macroblock type, reference index, motion vector and the like can be utilized as motion information of the current macroblock as they are. Yet, the motion skip mode may not be applicable to the following cases. For instance, it is not applied to a case that a current picture is a picture in a reference view compatible with conventional codec or corresponds to an inter-view picture group. The motion skip mode is applicable to a case that a corresponding block exists in a neighboring view and that the corresponding block is coded in inter-prediction mode. If the motion skip mode is applied, motion information of List0 reference picture is preferentially used according to the inter-view reference information. If necessary, motion information of List1 reference picture is usable as well.

According to an embodiment of the present invention, a method of applying a motion skip more efficiently, in case that at least one reference view is usable, is explained as follows.

Information on a reference view can be explicitly transported via a bitstream in an encoder or can be implicitly and randomly determined by a decoder. The explicit method and the implicit method are explained in the following description.

First of all, information indicating which one of views included in a reference view list is set to a reference view, i.e., view identification information of a reference view can be explicitly transported. In this case, the reference view list may mean a list of reference views constructed based on inter-view reference relation (view dependency).

For instance, if it is set to check whether views from one closest to a current view can be reference views among views belonging to the reference view list, it is unnecessary to explicitly transport view identification information of reference view. Yet, since reference view lists in directions L0 and L1 may exist in such a case, it is able to explicitly transport flag information indicating which one of the two will be firstly checked. For instance, it is able to determine whether the reference view list in the direction L0 or the reference view list in the direction L1 is firstly checked according to the flag information.

For another instance, it is able to explicitly transport number information of reference views to be used for motion skip. In this case, the number information of the reference views can be obtained from a sequence parameter set. And, it is able to explicitly transport a plurality of global motion vectors having vest efficiency calculated by an encoder. In this case, a plurality of the global motion vectors can be obtained from a slice header of a non-inter-view picture group. Thus, a plurality of the transported global motion vectors can be sequentially applied. For instance, in case that a block indicated by a global motion vector having best efficiency is coded in an intra-mode or unusable, it is able to check a block indicated by a global motion vector having second best efficiency. And, it is able to check all blocks indicated by a plurality of explicitly transported global motion vectors in the same manner.

For another instance, it is able to define flag information indicating whether a motion skip mode will be applied in a sequence. For instance, if motion_skip_flag_sequence is 1, a motion skip mode is applicable in a sequence. If motion_skip_flag_sequence is 0, a motion skip mode is not applied in a sequence. If so, it is able to re-check whether a motion skip mode will be applied in a slice or on a macroblock level.

If a motion skip mode is applied in a sequence according to the flag information, it is able to define a total number of reference views that will be used in the motion skip mode. For instance, num_of_views_minus1_for_ms may mean a total number of reference views that will be used in the motion skip mode. And, the num_of_views_minus1_for_ms can be obtained from an extension area of a sequence parameter set. It is able to obtain global motion vectors amounting to the total number of the reference views. In this case, the global motion vector can be obtained from a slice header. And, the global motion vector can be obtained only if a current slice corresponds to a non-inter-view picture group. Thus, a plurality of the obtained global motion vectors can be sequentially applied in the above-explained manner.

For another instance, a global motion vector can be obtained from an extension area of a sequence parameter set based on the number of reference views. For example, the global motion vectors can be obtained by being divided into a global motion vector in L0 direction and a global motion vector in L1 direction. In this case, the number of the reference views can be confirmed from inter-view reference information and can be obtained by being divided into the number of reference views in the L0 direction and the number of reference views in the L1 direction. In this case, all blocks within a slice use the same global motion vector obtained from the extension area of the sequence parameter set. And, different global motion vectors can be used in a macroblock layer. In this case, an index indicating the global motion vector may be identical to that of a global motion vector of a previously coded inter-view picture group. And, a view identification number of the global motion vector can be identical to an identification number of a view indicated by the global motion vector of the previously coded inter-view picture group.

For another instance, it is able to transport a view identification number of a corresponding block having best efficiency calculated by an encoder. Namely, a view identification number of a selected reference view can be coded on a macroblock level. Alternatively, a view identification number of a selected reference view can be coded on a slice level. Alternatively, flag information enabling either a slice level or a macroblock level to be selected can be defined on the slice level. For example, if the flag information indicates a use on a macroblock level, a view identification number of a reference view can be parsed on a macroblock level. Alternatively, in case that the flag information indicates a use on a slice level, a view identification number of a reference view is parsed on a slice level but is not parsed on a macroblock level.

Meanwhile, information indicating which one of reference views included in reference view lists in L0 and L1 directions will be selected as a reference view may not be transported. If so, by checking whether motion information exists in a corresponding block of each of the reference views, it is able to determine a final reference view and a corresponding block. There can exist various embodiments about which one of reference views belonging to a prescribed one of the reference view lists in the L0 and L1 directions will be most preferentially checked. If motion information does not exist in the reference view, there can exist various embodiments about order to perform checking thereafter.

For instance, in priorities between reference views belonging to a specific reference view list, first of all, it is able to check reference views in order of a lower index indicating a reference view among the reference views included in the reference view list in the L0 direction (or the reference view list in the L1 direction). In this case, the index indicating the reference view can be a series of numbers of reference views set in coding a bitstream in an encoder. For example, in representing a reference view of a non-inter-view picture group in sequence extension information (SPS extension) as non_anchor_ref_10[i] or non_anchor_ref_11[i], ‘i’ may be an index indicating a reference view. In the encoder, it is able to assign lower indexes in order of being closer to a current view, which does not put limitation on the present invention. If an index ‘i’ starts from 0, a reference view of ‘i=0’ is checked, a reference view of ‘i=1’ is checked, and a reference view of ‘i=2’ can be then checked. For another instance, it is able to check reference views in order of being closer to a current view among reference views included in the reference view list in the L0 direction (or the reference view list in the direction L1).

For another instance, it is able to check reference views in order of being closer to a base view among reference views included in the reference view list in the L0 direction (or the reference view list in the direction L1).

In priority between the L0-direction reference view list and the L1-direction reference vie list, a setting can be made in a manner of checking reference views belonging to the L0-direction reference view list rather than those belonging to the L1-direction reference view list. On the assumption of this setting, a case that a reference view exist in both of the L0-direction and L1-directon reference view lists and a case that a reference view exists in either the L0-direction or L1-directon reference view list are respectively explained as follows.

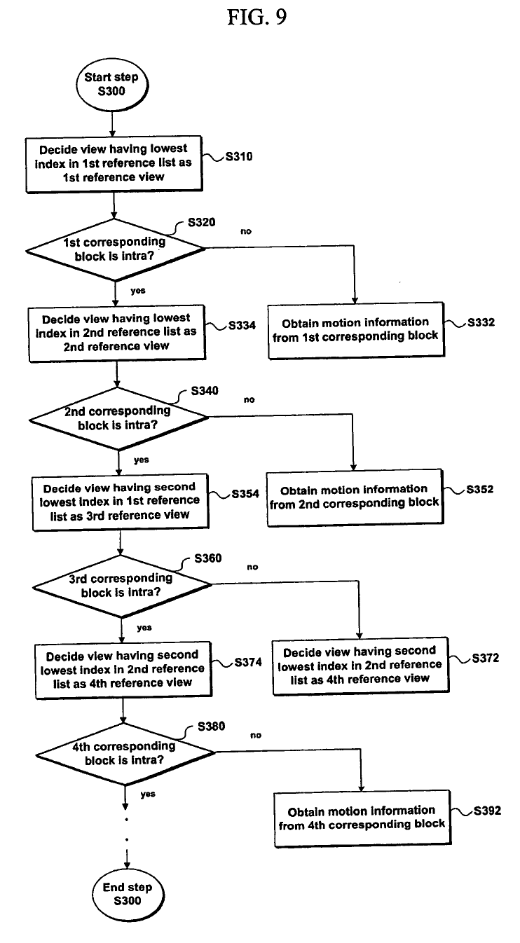

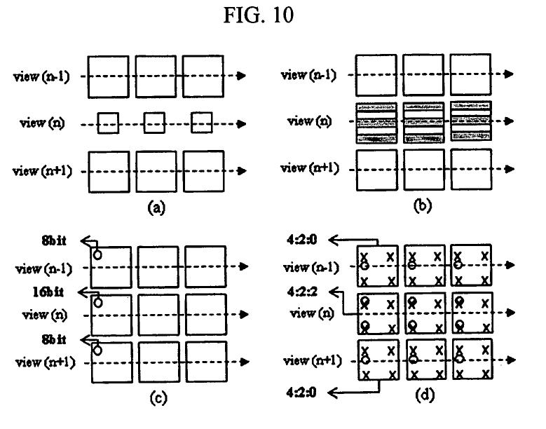

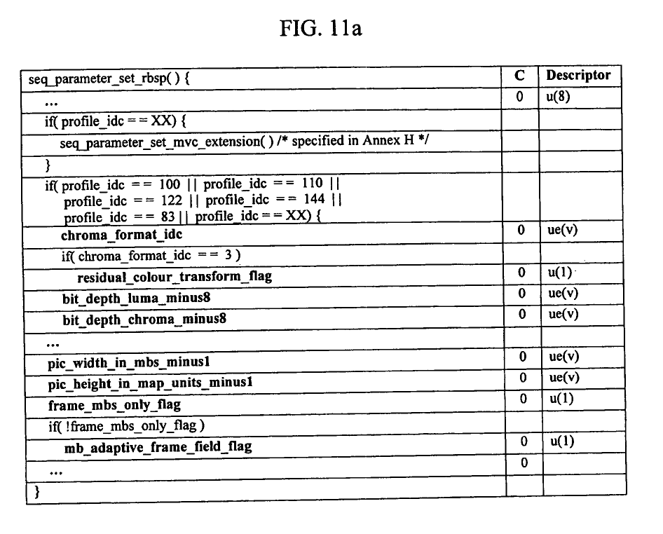

FIG. 8 and FIG. 9 are diagrams for an example of a method of determining a reference view and a corresponding block from a reference view list for a current view according to an embodiment of the present invention. Referring to FIG. 8 and FIG. 9, with reference to a current view Vc and a current block MBc, it can be observed that both a reference view list RL1 in L0 direction and a reference view list RL2 in L1 direction exist. In the L0-direction reference view list RL1, a view (V_{C-1}=non_anchor_ref_10[0]) having a lowest index indicating a reference view is determined as a first reference view RV1 and a block indicated by a global motion vector (GDV_10[0]) between the current view Vc and the first reference view RV1 can be determined as a first corresponding block CB1 [S310]. In case that the first corresponding block CB1 is not an intra block, i.e., if motion information exists [S320], the first corresponding block is finally determined as a corresponding block and motion information can be then obtained from the first corresponding block [S332].

On the other hand, if a block type of the first corresponding block CB1 is an intra-picture prediction block [S320], a view (V_{C+1}=non_anchor_ref_11[0]) having a lowest index indicating a reference view in the L1-direction reference view list RL2 is determined as a second reference view RV2 and a block indicated by a global motion vector (GDV11[0]) between the current view Vc and the second reference view RV2 can be determined as a second corresponding block CB2 [S334]. Like the above-mentioned steps S320, 5332 and S334, in case that motion information does not exist in the second corresponding block CB2, by determining a view (V_{C-2}=non_anchor_ref_10[0]) having a second lowest index indicating a reference view in the L0-direction reference view list RL1 as a third reference view RV3 and by determining a view (V_{C+2}=non_anchor_ref_11[0]) having a second lowest index indicating a reference view in the L1-direction reference view list RL2 as a fourth reference view RV4, third and fourth corresponding blocks CB3 and CB4 can be sequentially checked. Namely, by considering an index indicating a reference view, it is checked whether motion information exists by alternating the respective reference views of the L0-direction and L1-direction reference view lists RL1 and RL2.

If a view (e.g., non_anchor_ref_10[i], non_anchor_ref_11[i], i=0) having a lowest index in inter-view reference information on a current view is a view closest to the current view Vc, a selection reference for a candidate (i.e., the first reference view, the second reference view, etc.) for a reference view can be order closest to the current view Vc. Meanwhile, in case that a view having a lowest index is a view close to a base view, a selection reference for a candidate of a reference view can a base view or order closet to the base view, by which the present invention is not restricted.

For another instance, it is able to select a reference view based on reference information of a neighboring block. For example, in case that a neighboring block, of which reference information in view direction is available, does not exist in blocks neighboring to a current block, it is able to select a reference view based on inter-view reference relation (view dependency). Alternatively, in case that a single neighboring block, of which reference information in view direction is available, exists in blocks neighboring to a current block, the current block can use view direction reference information of the single neighboring block. Alternatively, in case that at least two neighboring blocks, of which reference information in view direction is available, exist in blocks neighboring to a current block, it is able to use view direction reference information of neighboring blocks having the reference information in the same view direction.

For another instance, it is able to select a reference view based on a block type of a block existing in a different view on a same time zone of a current block. For example, assume that 16×16 macroblock, 16×8 or 8×16 macroblock, 8×8 macroblock, 8×4 or 4×8 macroblock and 4×4 macroblock are level 0, level 1, level 2, level 3 and level 4, respectively. It is able to compare block types of corresponding blocks in a plurality of reference views. If the block types are identical to each other, it is able to select reference views from the reference view list in Lo or L1 direction by applying the above-mentioned method. On the other hand, if the block types are not identical to each other, it is able to preferentially select a reference view including a block on a more upper level. Alternatively, it is able to preferentially select a reference view including a block on a more lower level.

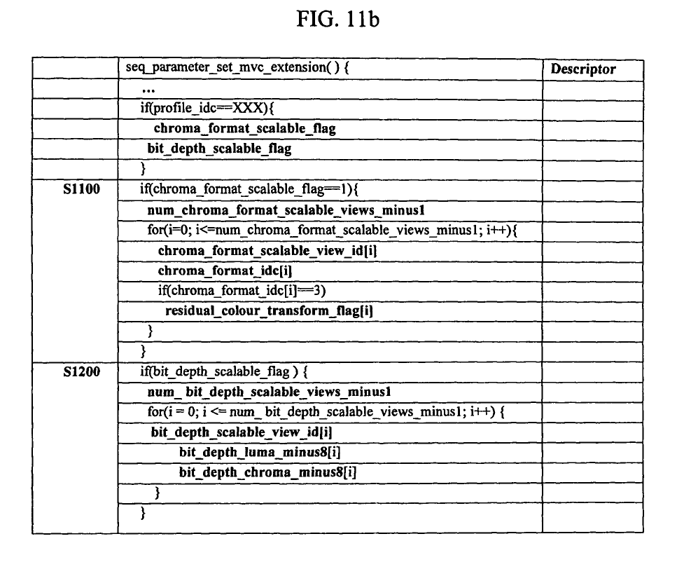

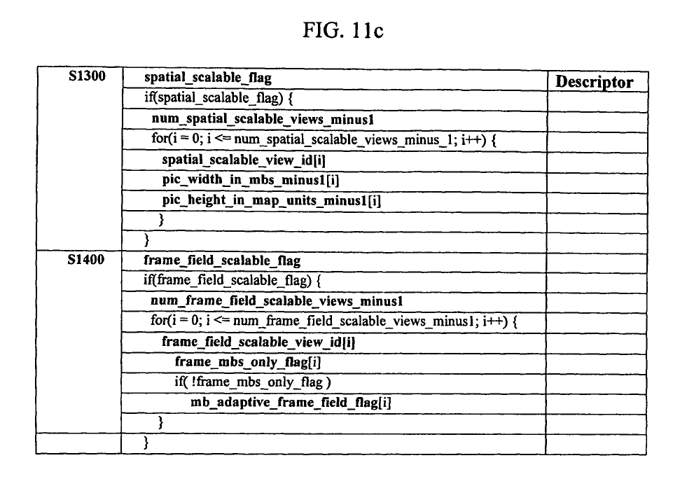

FIG. 10 and FIG. 11 are diagrams for examples of providing various scalabilities in multi-view video coding according to an embodiment of the present invention.

FIG. 10(a) shows spatial scalability, FIG. 10(b) shows frame/field scalability, FIG. 10(c) shows bit depth scalability, and FIG. 10(d) shows chroma format scalability.

According to an embodiment of the present invention, it is able to use sequence parameter set information independent for each view in multi-view video coding. If the sequence parameter set information independent for each view is used, informations on the various scalabilities can be independently applicable to each view.

According to another embodiment, entire views can use one sequence parameter set information only in multi-view video coding. If the entire views use one sequence parameter set information, the informations on the various scalabilities need to be newly defined within a single sequence parameter set. The various scalabilities are explained in detail as follows.

First of all, the spatial scalability in FIG. 10(a) is explained as follows.

Sequences captured in various views may differ from each other in spatial resolution due to various factors. For example, spatial resolution of each view may differ due to characteristic difference of camera. In this case, spatial resolution information for each view may be necessary for more efficient coding. For this, syntax information indicating resolution information can be defined [S1300].

First of all, it is able to define a flag indicating whether spatial resolutions of entire views are identical to each other. For example, if spatial_scalable_flag=0 in FIG. 11C, it may mean that coded pictures of all views may be identical to each other in width and height.

If spatial_scalable_flag=1, it may mean that coded pictures of all views may differ from each other in width and height. In case that spatial resolutions of the respective views are not identical according to the flag information, it is able to define information on a total number of views differing from a base view in spatial resolution. For example, a value resulting from adding 1 to a value of num_spatial_scalable_views_minus1 may mean a total number of views differ from a base view in spatial resolution.

According to the total number obtained in the above manner, it is able to obtain view identification information of views differing from a base view in spatial resolution. For example, spatial_scalable_view_id[i] may mean a view identification number of views differing from a base view in spatial resolution according to the total number.

According to the total number, it is able to obtain information indicating widths of coded pictures of the view having the view identification number. For example, in FIG. 11A and FIG. 11B, a value resulting from adding 1 to a value of pic_widthin_mbs_minus[i] may mean a width of a coded picture in a view differing from a base view in spatial resolution. In this case, the information indicating the width may be the information on macroblock unit. So, a with of picture for luminance component can be a value resulting from multiplying the value of pic_width_in_mbs_minus[i] by 16.

According to the total number, it is able to obtain information indicating heights of coded pictures in the same view of the view identification number. For example, a value resulting from adding 1 to a value of pic_height_in_map_units_minus[i] may mean a height of a coded frame/field of a view differing from a base view in spatial resolution. In this case, the information indicating the height may be the information on a slice group map unit. So, a size of picture may be a value resulting from multiplying the information indicating the width by the information indicating the height.

Secondly, frame/field scalability in FIG. 10(b) is explained as follows. Sequences captured in various views may differ from each other in coding scheme due to various factors. For example, each view sequence can be coded by one of frame coding scheme, field coding scheme, picture level field/frame adaptive coding scheme and macroblock level field/frame adaptive coding scheme. In this case, for more efficient coding, it is necessary to indicate each coding scheme for each view. For this, syntax information indicating the coding scheme can be defined [S1400].

First of all, it is able to define a flag indicating whether coding schemes of entire view sequences are identical to each other. For example, if frame_field_scalable_flag=0 in FIG. 11C, it may mean that flag information indicating a coding scheme of every view is identical. As an example of the flag information indicating the coding scheme, referring to FIG. 11A and FIG. 11C, there can be frame_mbs_only_flag or mb_adaptive_frame_field_flag. The frame_mbs_only_flag can mean flag information indicating whether a coded picture includes frame macroblock only. The mb_adaptive_frame_field_flag can mean flag information indicating whether switching between frame macroblock and field macroblock takes place within a frame. If the frame_field_scalable_flag=1, it may mean that flag information indicating a coding scheme differs for each view.

In case that coding scheme of each view is not identical according to the flag information, it is able to define information on a total number of views differing from a base view in scheme. For instance, a value resulting from adding 1 to a value of num_frame_field_scalable_views_minus1 may mean a total number of views differing from a base view in frame/field coding scheme.

According to the total number obtained in the above manner, it is able to obtain view identification information of views differing from a base view in coding scheme. For instance, frame_field_scalable_view_id[i] may mean a view identification number of a view differing from a base view in coding scheme.

According to the total number, it is able to obtain information indicating coding scheme of coded pictures in the same view of the view identification number. For instance, there can be frame_mbs_only_flag[i] and mb_adaptive_frame_field_flag[i]. This was explained in detail in the above description.

Thirdly, bit depth scalability is explained as follows. Sequences captured in various views may differ from each other in bit depth and quantization parameter range offset of a luminance signal and a chroma signal due to various factors. In this case, for more efficient coding, it is necessary to indicate bit depth and quantization parameter range offset for each view. For this, it is able to define syntax information indicating the bit depth and the quantization parameter range offset [S1200].

First of all, it is able to define a flag indicating whether bit depths and quantization parameter range offsets of the entire view sequences are identical to each other. For example, if bit_depth_scalable_flag=0, it may mean that the bit depths and quantization parameter range offsets of the entire view sequences are identical to each other. If bit_depth_scalable_flag=1, it may mean that the bit depths and quantization parameter range offsets of the entire view sequences are different from each other. The flag information can be obtained from an extension area of a sequence parameter set based on a profile identifier.

If the bit depths of the views are not identical to each other according to the flag information, it is able to define information on a total number of views differing from a base view. For example, a value resulting from adding 1 to a value of num_bit_depth_scalable_views_minus1 may mean a total number of views differing from a base view in bit depth. According to the total number obtained in this manner, it is able to obtain view identification information of views differing from a base view in bit depth. For example, bit_depth_scalable_view_id[i] may mean a view identification number of views differing from a base view in bit depth.

According to the total number, it is able to obtain information indicating bit depths and quantization parameter range offsets of luminance and chroma signals of a same view of the view identification number. For example, there are bit_depth_luma_minus8[i] and bit_depth_chroma_minus8[i] in FIG. 11A and FIG. 11B. The bit_depth_luma_minus8[i] can mean a bit depth and a quantization parameter range offset of a view differing from a base view in bit depth. In this case, the bit depth may be the information on the luminance signal. The bit_depth_chroma_minus8[i] can mean a bit depth and a quantization parameter range offset of a view differing from a base view in bit depth. In this case, the bit depth may be the information on the chroma signal. Using the bit depth informations and the width and height informations of macroblock, it is able to know bits (RawMbBits[i]) of an original macroblock of the same view of the view identification number.

Fourthly, chroma format scalability shown in FIG. 10(d) is explained as follows. Sequences captured in various views may differ from each other in sequence format for each view due to various factors. In this case, for more efficient coding, it is necessary to indicate the sequence format of each view. For this, syntax information indicating the sequence format can be defined [S1100].

First of all, it is able to define a flag indicating whether sequence formats in entire views are identical to each other. For example, if chroma_format_scalable_flag=0, it may mean that sequence formats in entire views are identical to each other. Namely, it may mean that a ratio of a luminance sample to a chroma sample is identical. If chroma_format_scalable_flag=1, it may mean that sequence formats in views are different from each other. The flag can be obtained from an extension area of a sequence parameter set based on a profile identifier.

If the sequence formats of the respective views are not identical according to the flag, it is able to define information on a total number of views differing from a base view in sequence format. For instance, a value resulting from adding 1 to a value of num_chroma_format_scalable_views_minus' may mean a total number of views differing from a base view in sequence format.

According to the total number obtained in the above manner, it is able to obtain view identification information of views differing from a base view in sequence format. For example, chroma_format_scalable_view_id[i] may mean a view identification number of a view differing from a base view in sequence format according to the total number.

According to the total number, it is able to obtain information indicating a sequence format of a view having the view identification number. For example, chroma_format_idc[i] in FIG. 11B may mean a sequence format of a view differing from a base view in sequence format. In particular, it may mean 4:4:4 format, 4:2:2 format or 4:2:0 format. In this case, if the chroma_format_idc[i] indicates 4:4:4 format, it is able to obtain flag information (residual_colour_transform_flag[i]) indicating whether a residual color transform process is applied.

As mentioned in the foregoing description, the decoding/encoding device, to which the present invention is applied, is provided to a transmitter/receiver for multimedia broadcasting such as DMB (digital multimedia broadcast) to be used in decoding video and data signals and the like. And, the multimedia broadcast transmitter/receiver can include a mobile communication terminal.

A decoding/encoding method, to which the present invention is applied, is configured with a program for computer execution and then stored in a computer-readable recording medium. And, multimedia data having a data structure of the present invention can be stored in computer-readable recording medium. The computer-readable recording media include all kinds of storage devices for storing data that can be read by a computer system. The computer-readable recording media include ROM, RAM, CD-ROM, magnetic tapes, floppy discs, optical data storage devices, etc. and also includes a device implemented with carrier waves (e.g., transmission via internet). And, a bitstream generated by the encoding method is stored in a computer-readable recording medium or transmitted via wire/wireless communication network.

### INDUSTRIAL APPLICABILITY

Accordingly, while the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method of decoding a video signal, comprising:
obtaining identification information indicating whether a coded picture of a current NAL unit is included in an inter-view picture group;
obtaining inter-view reference information of a non-inter-view picture group according to the identification information;
obtaining a motion vector according to the inter-view reference information of the non-inter-view picture group;
deriving a position of a first corresponding block using the motion vector; and
decoding a current block using motion information of the derived first corresponding block,
wherein the inter-view reference information includes number information of reference views of the non-inter-view picture group.

2. The method of claim 1, further comprising checking a block type of the derived first corresponding block, wherein it is determined whether to derive a position of a second corresponding block existing in a reference view differing from a view of the first corresponding block based on the block type of the first corresponding block.

3. The method of claim 2, wherein the positions of the first and second corresponding blocks are derived based on a predetermined order and wherein the predetermined order is configured in a manner of preferentially using the reference view for a L0 direction of the non-inter-view picture group and then using the reference view for a L1 direction of the non-inter-view picture group.

4. The method of claim 3, wherein if the block type of the first corresponding block is an intra block, the reference view for the L1 direction is usable.

5. The method of claim 3, wherein the reference views for the L0/L1 direction are used in order of being closest to a current view.

6. The method of claim 1, further comprising obtaining flag information indicating whether motion information of the current block will be derived, wherein the position of the first corresponding block is derived based on the flag information.

7. The method of claim 1, further comprising:
obtaining motion information of the first corresponding block; and
deriving motion information of the current block based on the motion information of the first corresponding block,
wherein the current block is decoded using the motion information of the current block.

8. The method of claim 1, wherein the motion information includes a motion vector and a reference index.

9. The method of claim 1, wherein the motion vector is a global motion vector of the inter-view picture group.

10. An apparatus for decoding a video signal, comprising:
a reference information obtaining unit obtaining inter-view reference information of a non-inter-view picture group according to identification information indicating whether a coded picture of a current NAL unit is an inter-view picture group; and
a corresponding block searching unit deriving a position of a corresponding block using a global motion vector of a inter-view picture group obtained according to the inter-view reference information of the non-inter-view picture group,
wherein the inter-view reference information includes number information of reference views of the non-inter-view picture group.

11. The method of claim 1, wherein the video signal is received as a broadcast signal.

12. The method of claim 1, wherein the video signal is received via a digital medium.

13. A computer-readable medium comprising a program for executing the method of claim 1, the program recorded in the computer-readable medium.
